(19) United States
(12) Patent Application Publication
(10) Pub. No.: US 2012/0304844 A1
(43) Pub. Date: Dec. 6, 2012

(54) MATERIAL CUTTING DIE

(75) Inventors: Kevin L. Obrachta, Wichita, KS (US); Steven Samuel Hobson, Derby, KS (US); Ryan Craig Harris, Derby, KS (US)

(73) Assignee: Spirit AeroSystems, Inc., Wichita, KS (US)

(21) Appl. No.: 13/150,480

(22) Filed: Jun. 1, 2011

(51) Int. Cl. B26D 1/02

(52) U.S. Cl. 83/856

(57) ABSTRACT

A die for forming an elongated strand of continuous material includes a front surface, an opposing back surface, a peripheral surface positioned therebetween, a groove, and a pair of peaks. The groove may be located on the front surface and may originate near the center of the front surface and terminate at the edge of the front surface. The groove may revolve around the center, getting progressively farther away from the center as it revolves. The peaks may be located at opposing edges of the groove, wherein the peaks of one portion of the groove contact the peaks of neighboring portions of the groove to form a blade. The die is pressed against an adhesive charge, such that the blade cuts the material to form an elongated, continuous noodle.

### BACKGROUND OF THE INVENTION

1. Field of the Invention

Embodiments of the present invention relate to an apparatus and methods for forming elongated strands of continuous material.

2. Description of the Related Art

Noodles is the informal name used to describe the elongated strands of adhesive used to fillet the space between two or more intersections of structural elements within a composite structure, such as the internal space created between the cap and web of an I-beam or T-stiffener, or the external space where a stringer and skin are joined. These fillets are prevalent in composite aircraft structures such the fuselage, wing, or control surfaces but might also occur in other composite structural applications such as windmill blades or boats for example. In aircraft applications, these noodles are typically manufactured from a qualified film adhesive. The noodle making process generally involves the cutting and forming of the film adhesive into short lengths of linear noodle. Often the noodle-making process is manual, although various noodle making machines have been developed to improve the productivity of the noodle making process. These noodles are generally short, typically 2-3 feet in length, to facilitate handling. These short linear noodles are a suitable form for manual insertion on smaller structures. On larger composite aircraft structures however, such as a composite fuselage panel, there is a need to manufacture perhaps several thousand feet of noodle and to insert thousands of discrete noodle pieces. The insertion process involves frequent trips between workpiece and workbench to retrieve noodles, correctly positioning the noodle shape into the fillet space (in terms of both axial angular orientation and linear position), and butt splicing the noodle to the end of the previously placed noodle. Careful handling is necessary to avoid distorting the fillet shape or entangling the noodles. Consequently, the noodle making, handling, and insertion processes can be very time-consuming and labor-intensive for larger structures.

### SUMMARY OF THE INVENTION

Embodiments of the present invention solve the above-mentioned problems and provide a distinct advance in the art of an apparatus and method for making an elongated strand of continuous material, such as an adhesive noodle, that is more time and labor efficient for handling and inserting into a long fillet space.

Embodiments of the present invention may include a die for forming an elongated strand of continuous material broadly comprising a front surface, an opposing back surface, a peripheral surface positioned therebetween, a groove, and a pair of peaks. The groove may be located on the front surface and may originate near the center of the front surface and terminate at the edge of the front surface. The groove may revolve around the center, getting progressively farther away from the center as it revolves. The peaks may be located at opposing edges of the groove, wherein the peaks of one portion of the groove contact the peaks of neighboring portions of the groove to form a blade. The die is pressed against an adhesive charge, such that the blade cuts the charge to form an elongated, continuous noodle. The die may further include a plurality of vents positioned along a valley of the groove, such that air may flow through the vents to lift the noodle after it has been formed.

Embodiments of the present invention may also include a method of forming an elongated strand of continuous material. The method may include the steps of placing the material in contact with a die that includes a groove located on a front surface that originates near the center of the front surface and terminates at the edge of the front surface, wherein the groove revolves around the center, getting progressively farther away from the center as it revolves, the die further including a pair of peaks located at opposing edges of the groove, wherein the peaks of one portion of the groove contact the peaks of neighboring portions of the groove to form a blade and pressing the die against the material such that the blade cuts the material into a single, continuous strand. The method may further include the step of forcing air through a plurality of vents located in a valley of the groove to lift the material from the groove.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a die, constructed in accordance with a first embodiment of the present invention, presenting a front surface that includes a groove for forming a noodle;

FIG. 2 is a cross-sectional view of the die, cut along the line 2-2 from FIG. 1;

FIG. 3 is a perspective view of the die, constructed in accordance with a second embodiment of the present invention, that includes the groove and a plurality of vents;

FIG. 4 is a cross-sectional view of the die, cut along the line 4-4 from FIG. 3;

FIG. 5 is a perspective view of an adhesive charge used to form the noodle;

FIG. 6 is a perspective view of the noodle;

FIG. 7 is a press in which the die and the adhesive charge are placed; and

FIG. 8 is a flow diagram of at least a portion of the steps of a method of forming an elongated strand of continuous material.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

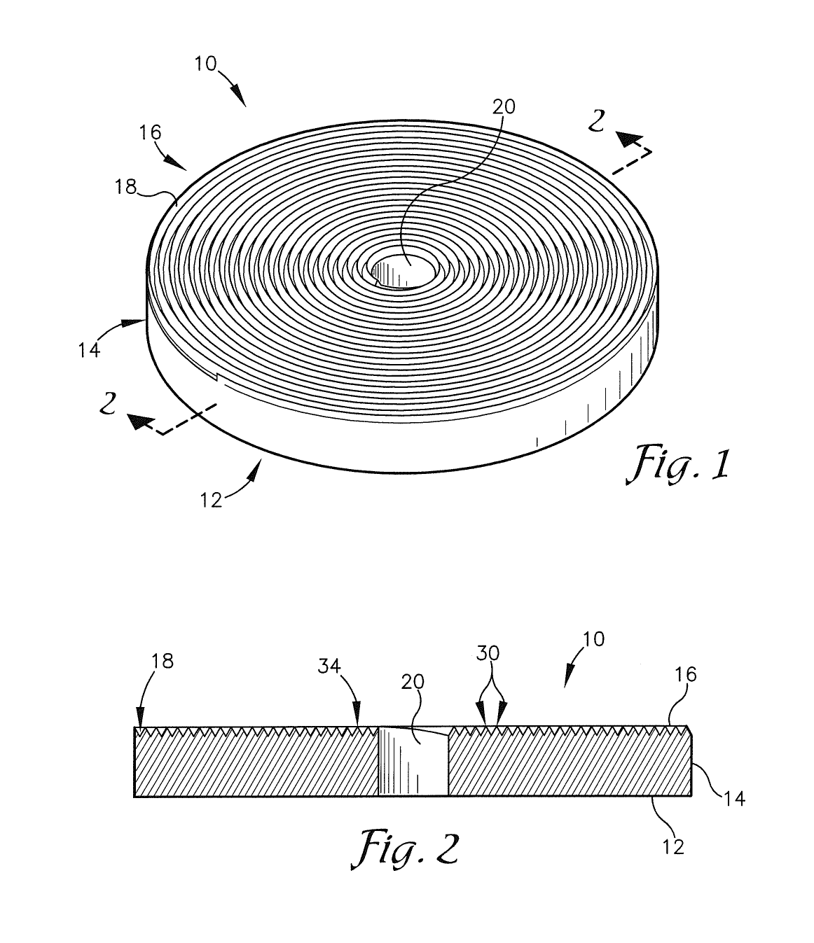

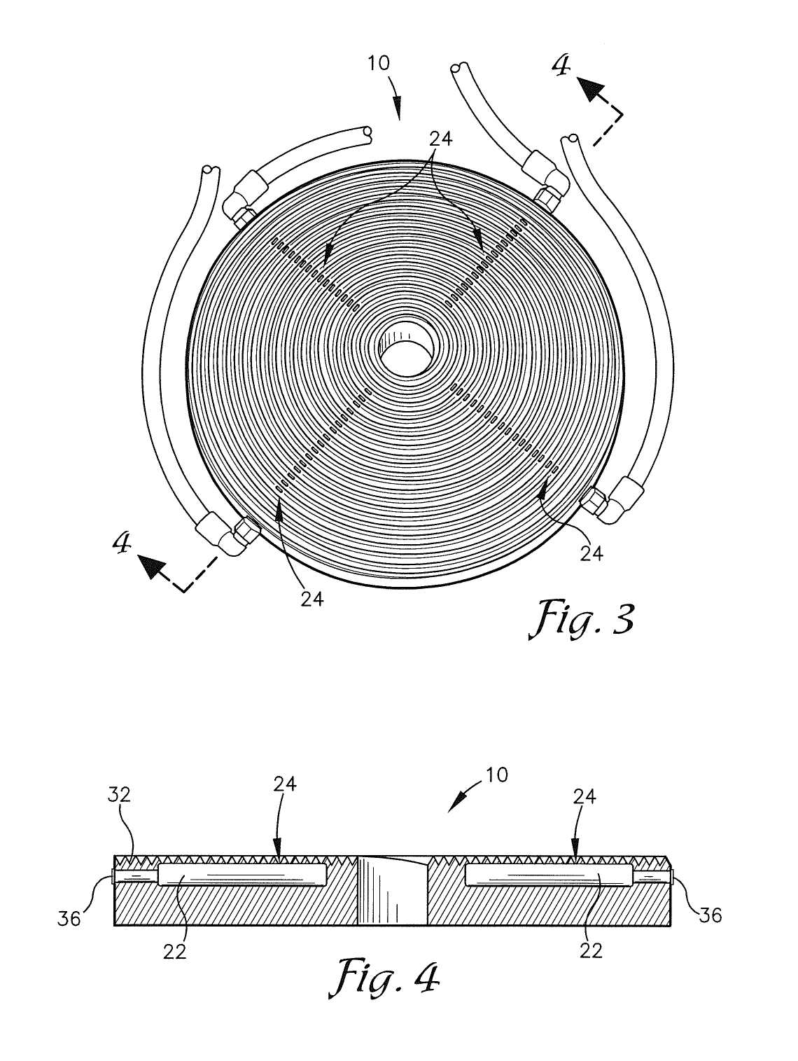

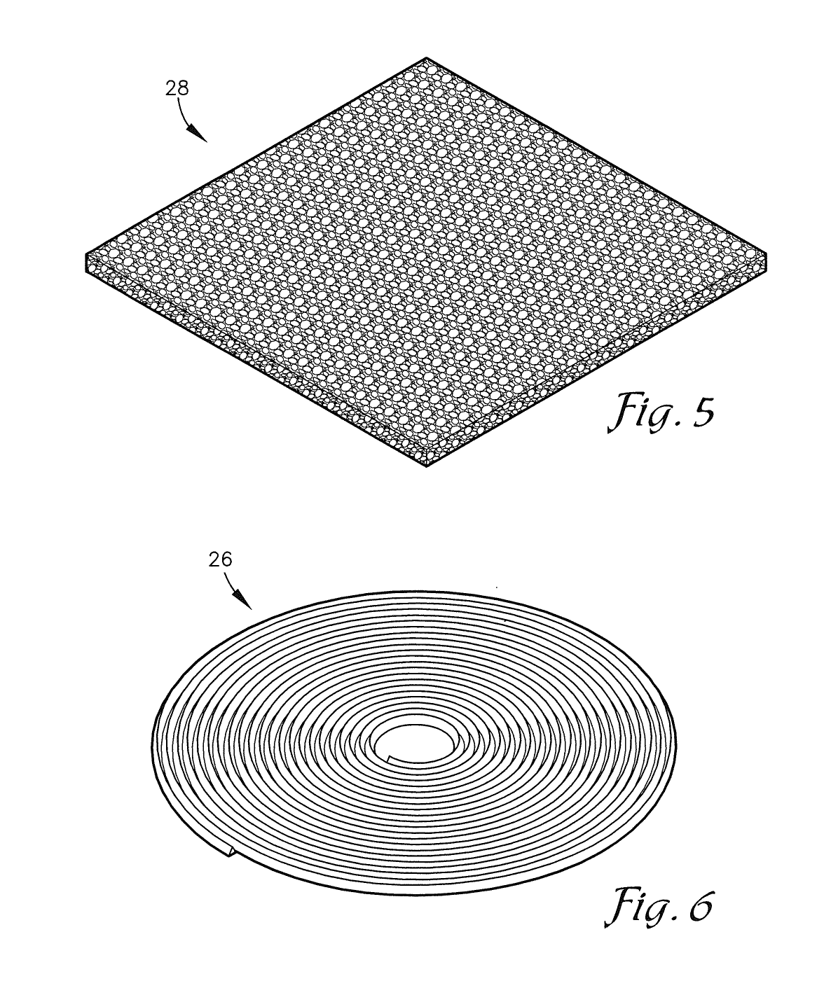

A die 10, constructed in accordance with various embodiments of the present invention, for forming an elongated strand of continuous material is shown in FIGS. 1 and 2. The die 10 may broadly comprise a back surface 12, a peripheral surface 14, a front surface 16, a groove 18, and a hole 20. In various embodiments, the die 10 may further include at least one internal cavity 22 and a plurality of vents 24, as shown in FIGS. 3 and 4. The die 10 may be utilized to form a noodle 26, as shown in FIG. 6, that is inserted into a fillet space during the construction of an aircraft.

The noodle 26 may be created from a stack of multiple layers of an adhesive charge 28 that is pre-compacted, as shown in FIG. 5. Typically, the adhesive charge 28 is fabricated in a large sheet from which smaller squares approximately the size of the die 10 are cut. The adhesive charge 28 may include a thin non-stick film that covers an outer surface on one side of the adhesive charge 28. In some embodiments, the non-stick film may cover both sides of the adhesive charge 28.

The die 10 is generally round or disc shaped, although other shapes may be possible, such as a square or a rectangle. The die 10 may be formed from materials that can produce a suitable cutting edge without excessive deflection or wear, such as certain metals. An exemplary material for the die 10 is aluminum or steel.

The front surface 16 generally opposes the back surface 12 with the peripheral surface 14 positioned therebetween and surrounding the die 10. The hole 20 may be centrally-located and cylindrical, extending from the front surface 16 to the back surface 12.

The groove 18 may be located on the front surface 16 of the die 10 and may be oriented such that the groove 18 starts at or near the center of the front surface 16 (or near the hole 20, in embodiments that include the hole 20) and terminates at the edge, adjacent to the peripheral surface 14. The groove 18 revolves around the center, getting progressively farther away from the center as it revolves. In various embodiments, the groove 18 may have an Archimedean spiral shape. In other embodiments wherein the die 10 is square or rectangular, the groove 18 may be oriented as a square spiral such that when moving outward from the center of the die 10, each progressive side of the groove 18 is increasingly greater in length.

The groove 18 may include peaks 30 along the edges of the groove 18 and a valley 32 in the center of the groove 18. In addition, the groove 18 may be positioned such that peaks 30 of one portion of the groove 18 contact the peaks 30 of neighboring portions of the groove 18. The intersection of the peaks 30 of the groove 18 may form a blade 34 that is operable to cut the adhesive charge 28 when the die 10 is pressed against the adhesive charge 28. During the cutting process, the noodle 26 is formed within the groove 18.

The groove 18 may have an equilateral triangle cross-sectional shape, as seen in FIG. 2, although other shapes are possible, such as a non-equilateral triangle, a U-shape, a semicircle, a square, or a rectangular. The groove 18 may be formed by machining the front surface 16 of the die 10, or by various other metallurgy forming processes.

The internal cavity 22 may include a hollow space of cylindrical or tubular shape positioned between the front surface 16 and the back surface 12 within the body of the die 10. The internal cavity 22 may be accessed through an opening 36 in the peripheral surface 14. The opening 36 may include a fitting or coupler to connect to a hose through which air can be supplied to the internal cavity 22 from an external air source. The internal cavity 22 may be formed by machining, milling, drilling, or other metal cutting techniques.

The vents 24 may include holes or openings that connect the internal cavity 22 to the front surface 16 of the die 10, as seen in FIG. 4. In various embodiments, the vents 24 may be rectangular in shape. The vents 24 may be located in the valley 32 along neighboring portions of the groove 18, such that the vents 24 are aligned with the radius of the die 10. The vents 24 may be formed at the same time and by the same process that forms the internal cavity 22, such that the upper boundary of the internal cavity 22 overlaps the valley 32 of the groove 18. The vents 24 may receive air through the internal cavity 22 to help eject the noodle 26 from the groove 18 after the noodle 26 is formed.

An exemplary die 10 is approximately 8 inches in diameter and approximately 1 inch thick, and may include four internal cavities 22 with four corresponding vents 24 spaced 90 degrees apart. An exemplary groove 18 has an equilateral triangle cross section that is approximately 0.152 inches in width and has a depth of approximately 0.132 inches. The space between the centers of adjacent portions of the groove 18 is approximately 0.152 inches. The number of adjacent portions of the groove 18 of the exemplary die 10 is approximately 23 for a die 10 with a 1-inch diameter hole 20, and approximately 26 for a die 10 with no hole 20. The exemplary die 10 and groove 18 may produce a noodle 26 that is approximately 27 feet in length.

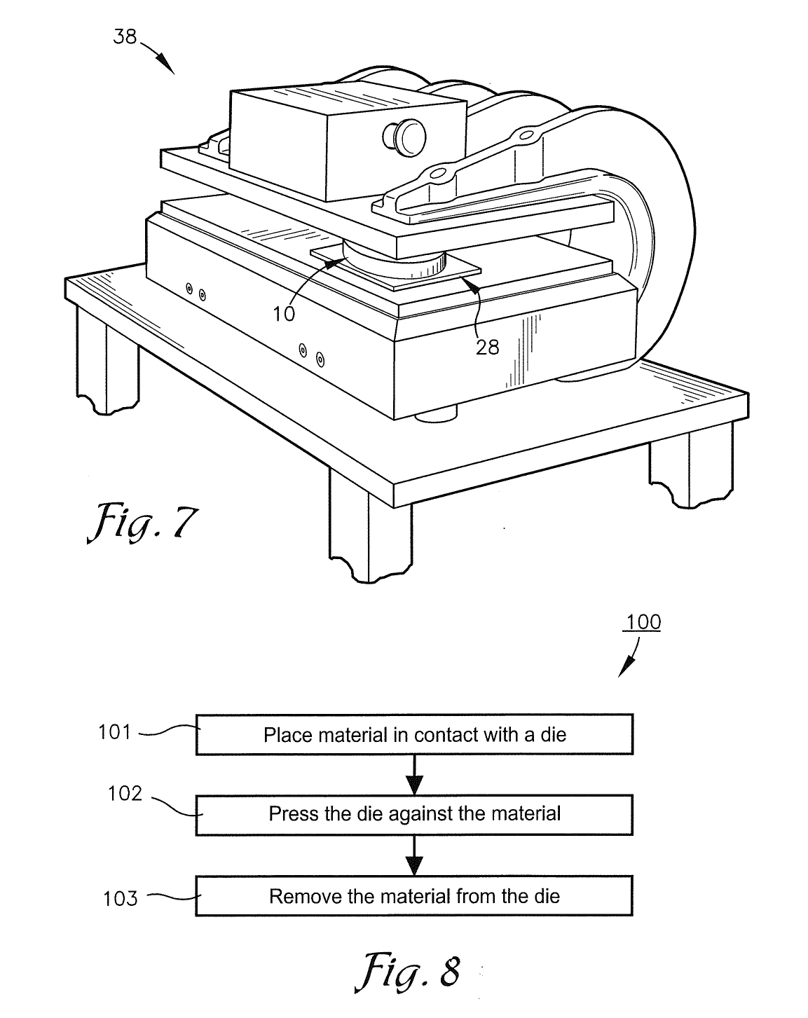

The die 10 may be used as follows. The adhesive charge 28 is stacked and pre-compacted. The die 10 may be loaded into a press 38, as shown in FIG. 7. The press 38 may be any device or apparatus that is capable of applying a large amount of pressure to an object. An exemplary press 38 is the Clicker 1500 from Tippmann Industrial Products, Inc. of Fort Wayne, Ind. The adhesive charge 28 may be placed against the front surface 16 of the die 10. Precise alignment of the adhesive charge 28 with the groove 18 is not required, although adhesive charge 28 material that extends beyond the area of die 10 may be trimmed away.

The press 38 may be activated and the die 10 may be pressed into the adhesive charge 28 with 10-20 tons of pressure. The pressure of the die 10 against the adhesive charge 28 allows the blade 34 formed by the peaks 30 of the groove 18 to cut the adhesive charge 28 into a noodle 26 that is wound in a spiral, as shown in FIG. 6. The press 38 may be opened and air may be forced into the internal cavity 22 and through the vents 24 to lift the noodle 26, which may then be removed from the groove 18 of the die 10 and placed into fillet spaces where two aircraft structural components intersect. Generally, the adhesive charge 28 is cut all the way through so that the noodle 26 is easily removed. Occasionally, portions of the noodle 26 may be stuck together which can be separated with a gentle pull.

In certain embodiments, the die 10 may serve as a dispenser for the noodle 26, wherein a shaft that may be rotatable is inserted in the hole 20 of the die 10. After the noodle 26 is formed, it may then be spooled from the groove 18 and inserted into the fillet space. In other embodiments, a plurality of dies 10 may be placed on a rotatable shaft such that a plurality of noodles 26, one from each die 10, is spooled from the grooves 18 of the dies 10 and inserted into multiple fillet spaces. In alternative embodiments, a separate flat plate may receive the noodle 26 from the die 10, and the plate may act as a dispenser for the noodle 26.

Steps of a method 100 for forming elongated strands of continuous material in accordance with various embodiments of the present invention are illustrated in FIG. 8. The steps may be performed in the order shown in FIG. 8, or they may be performed in a different order. Furthermore, some steps may be performed concurrently as opposed to sequentially. In addition, some steps may be optional.

Referring to step 101, material is placed in contact with a die 10. The die 10 may include a groove 18 located on a front surface 16 that originates near the center of the front surface 16 and terminates at the edge of the front surface 16. The groove 18 revolves around the center, getting progressively farther away from the center as it revolves. The die 10 may further include a pair of peaks 30 located at opposing edges of the groove 18, wherein the peaks 30 of one portion of the groove 18 contact the peaks 30 of neighboring portions of the groove 18 to form a blade 34. The material may be an adhesive charge 28 that is used to create a noodle 26, which may be placed into fillet spaces where two aircraft structural components intersect.

Referring to step 102, the die 10 is pressed against the material such that the blade 34 cuts the material into a single, continuous strand. The die 10 may be placed in a press 38, as seen in FIG. 7, capable of applying a large amount of pressure. The press 38 may be activated and apply 10-20 tons of pressure to the die 10 which in turn presses against the adhesive charge 28. The blade 34 may cut the adhesive charge 28 into a single continuous noodle 26 that is in the shape of a spiral, as shown in FIG. 6.

Referring to step 103, the noodle 26 is removed from the groove 18 of the die 10. In some embodiments, the noodle 26 may be removed manually. In other embodiments, the noodle 26 may be removed by forcing air into an internal cavity 22 of the die 10 and through vents 24 located in the valley 32 of the groove 18 to lift the noodle 26, which may then be taken from the groove 18 of the die 10 and placed into fillet spaces where two aircraft structural components intersect.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A die for forming an elongated strand of continuous material, the die comprising:
a front surface, an opposing back surface, and a peripheral surface positioned therebetween;
a spiral groove formed in the front surface that originates near a center of the front surface and terminates at an edge of the front surface, wherein the groove revolves around the center, getting progressively farther away from the center as it revolves; and
a pair of peaks located at opposing edges of the groove, wherein the peaks of one portion of the groove contact the peaks of neighboring portions of the groove to form a blade.

2. The die of claim 1, further including a plurality of vents through which air flows to lift the material, the vents positioned along a valley of the groove.

3. The die of claim 2, further including at least one internal cavity positioned between the front surface and the back surface and accessed through the peripheral surface, the internal cavity providing an air passage from an external air source to the vents.

4. The die of claim 1, wherein the groove has an equilateral triangle cross-sectional shape.

5. The die of claim 1, wherein the groove has a depth of approximately 0.132 inches.

6. The die of claim 1, wherein the groove has a width of approximately 0.152 inches.

7. The die of claim 1, wherein the distance between centers of adjacent portions of the groove is approximately 0.152 inches.

8. The die of claim 1, wherein there are approximately twenty-six adjacent portions of the groove on the die.

9. A method of forming an elongated strand of continuous material, the method comprising the steps of:
a) placing the material in contact with a die that includes a groove located on a front surface that originates near a center of the front surface and terminates at an edge of the front surface, wherein the groove revolves around the center, getting progressively farther away from the center as it revolves, the die further including a pair of peaks located at opposing edges of the groove, wherein the peaks of one portion of the groove contact the peaks of neighboring portions of the groove to form a blade; and
b) pressing the die against the material such that the blade cuts the material into a single, continuous strand.

10. The method claim 9, further including the step of forcing air through a plurality of vents located in a valley of the groove to lift the material from the groove.

11. The method claim 9, wherein after being cut, the single, continuous strand is in the shape of a spiral.

12. The method claim 9, wherein the cross-sectional shape of the groove is an equilateral triangle.
